(19) United States
(12) Patent Application Publication
(10) Pub. No.: US 2004/0199755 A1
(43) Pub. Date: Oct. 7, 2004

(54) Apparatus and methods for exception handling for fused micro-operations by re-issue in the unfused format

(76) Inventors: Zeev Sperber, Zichron Yaakov (IL); Robert Valentine, Kyriat Tivon (IL); Ittai Anati, Haifa (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/407,469

(22) Filed: Apr. 7, 2003

(51) Int. Cl. G06F 9/00

(52) U.S. Cl. 712/244; 712/245

(57) ABSTRACT

In some embodiments of the invention, an instruction decoder has a fused decoding mode and an unfused decoding mode. If an exception occurs during execution of a fused micro-operation that was decoded from a particular macroinstruction, then an exception handler may cause the particular macroinstruction to be decoded by the instruction decoder in unfused decoding mode.

### BACKGROUND OF THE INVENTION

When decoding a macroinstruction into micro-operations for execution by an execution cluster of a processor core, an instruction decoder of the processor core may generate “fused” micro-operations having two or more steps. In some processor designs, designing microcode to handle all exceptions that occur during execution of one of the steps of a fused micro-operation may be a complex task and the resultant microcode may occupy a lot of storage space.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is a block diagram of an apparatus comprising a processor having a processor core in accordance with at least one embodiment of the invention;

FIG. 2 is a flowchart illustration of part of an exemplary method of handling macroinstructions in the processor core, according to at least one embodiment of the invention;

FIG. 3 is a flowchart illustration of a method implemented by the reorder buffer, according to at least one embodiment of the invention; and

FIG. 4 is a flowchart illustration of a method implemented by the microcode read-only-memory (ROM), according to at least one embodiment of the invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF EMBODIMENTS OF THE INVENTION

In the following detailed description, numerous specific details are set forth in order to provide a thorough understanding of embodiments of the invention. However it will be understood by those of ordinary still in the art that the embodiments of the invention may be practiced without these specific details. In other instances, well-known methods, procedures, components and circuits have not been described in detail so as not to obscure the embodiments of the invention.

It should be understood that embodiments of the invention may be used in any apparatus having a processor. Although embodiments of the invention are not limited in this respect, the apparatus may be a portable device that may be powered by a battery. A non-exhaustive list of examples of such portable devices includes laptop and notebook computers, mobile telephones, personal digital assistants (PDA), and the like. Alternatively, the apparatus may be a non-portable device, such as, for example, a desktop computer or a server computer.

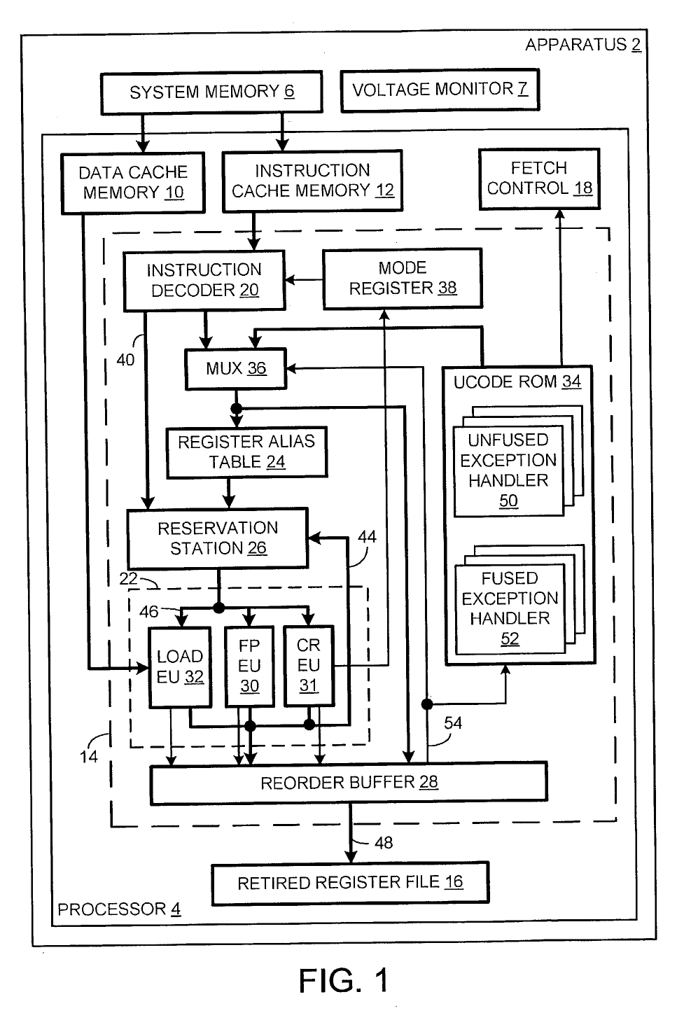

As shown in FIG. 1, an apparatus 2 may include a processor 4 and a system memory 6 according to at least one embodiment of the invention.

Although embodiments of the invention are not limited in this respect, processor 4 may be, for example, a central processing unit (CPU), a digital signal processor (DSP), a reduced instruction set computer (RISC), a complex instruction set computer (CISC) and the like. Moreover, processor 4 may be part of an application specific integrated circuit (ASIC).

Although embodiments of the invention are not limited in this respect, system memory 6 may be, for example, a dynamic random access memory (DRAM), a synchronous dynamic random access memory (SDRAM), a flash memory, a double data rate (DDR) memory, RAMBUS dynamic random access memory (RDRAM) and the like. Moreover, system memory 6 may be part of an application specific integrated circuit (ASIC).

Apparatus 2 may also optionally include a voltage monitor 7.

System memory 6 may store macroinstructions to be executed by processor 4. System memory 6 may also store data for the macroinstructions, or the data may be stored elsewhere.

Processor 4 may include a data cache memory 10, an instruction cache memory 12, a fetch control 18, a processor core 14 and a retired register file 16.

Although embodiments of the invention are not limited to this embodiment, fetch control 18 may fetch macro instructions and the data for those macroinstructions from system memory 6, and may store the macroinstructions in instruction cache memory 12 and the data for those macroinstructions in data cache memory 10, for use by processor core 14. Fetch control 18 may then fetch macroinstructions from instruction cache memory 12 into processor core 14.

Processor core 14 may receive macroinstructions from instruction cache memory 12, decode them into micro-operations (“u-ops”) and execute them. Once a macroinstruction has been executed by processor core 14, the results of the execution may be retired to retired register file 16. Well-known components and circuits of processor core 14 are not shown in FIG. 1 so as not to obscure the invention. Design considerations, such as, but not limited to, processor performance, cost and power consumption, may result in a particular processor core design, and it should be understood that the design of processor core 14 shown in FIG. 1 is merely an example and that embodiments of the invention are applicable to other processor core designs as well.

Although embodiments of the invention are not limited to this embodiment, processor core 14 may be designed for out-of-order execution of u-ops, i.e. u-ops may be executed according to availability of operands and execution resources inside processor core 14, or according to some other criterion, and not necessarily according to the order in which they were generated from the macroinstruction. In some cases, a u-op generated from a particular macroinstruction may be executed after a u-op generated from a later macroinstruction. However, results for macroinstructions will be retired in the same order that the macroinstructions were received by processor core 14.

Processor core 14 may include an instruction decoder 20 and an execution cluster 22 having execution units (EUs), for example, a floating point EU 30, a control register EU 31, and a load EU 32. Execution cluster 22 may include additional execution units that are not shown in FIG. 1 so as not to obscure the invention. For the purpose of out-of-order execution of u-ops, processor core 14 may also include a register alias table (RAT) 24, a reservation station (RS) 26, and a reorder buffer (ROB) 28. Moreover, for the purpose of exception handling, processor core 14 may include a microcode read only memory (uROM) 34, a micro-operation multiplexer (“MUX”) 36 and a decoding mode register 38. In alternate embodiments the microcode may be stored in a memory that is not a read only memory.

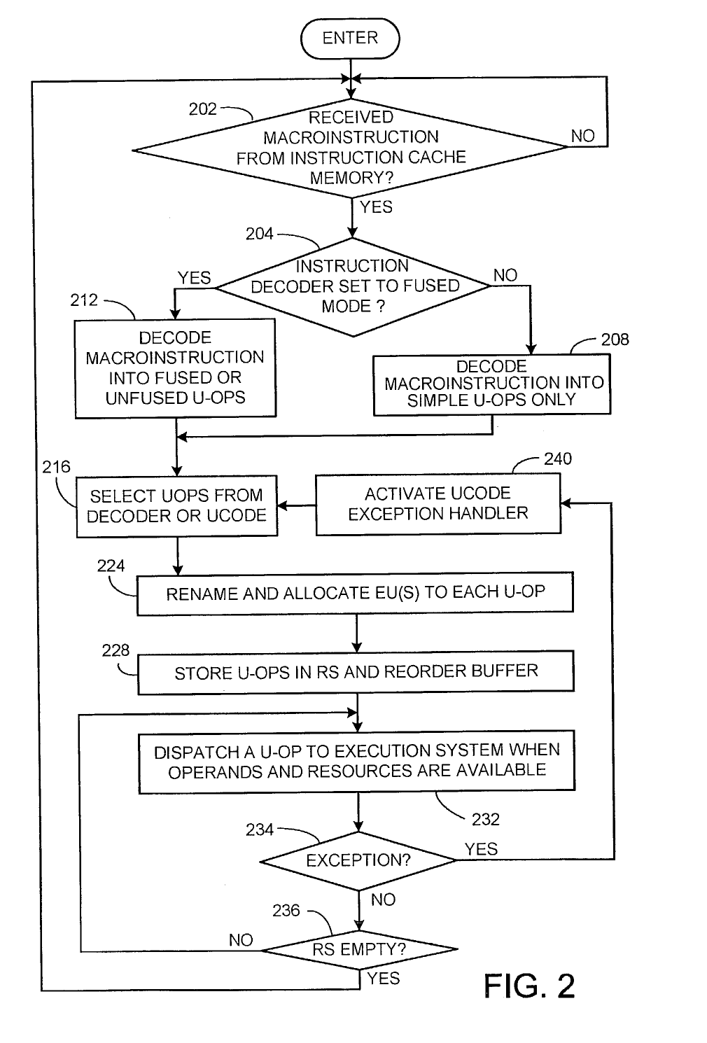

Reference is now made additionally to FIG. 2, which is a flowchart illustration of part of an exemplary method of handling macroinstructions in the processor core, according to at least one embodiment of the invention.

Instruction decoder 20 may receive macroinstructions from instruction cache memory 12 (-202-), and may decode each macroinstruction into one or more u-ops, depending upon the type of the macroinstruction. A u-op is an operation to be executed by execution cluster 22. Each u-op may include operands and an op-code, where “op-code” is a field of the u-op defining the type of operation to be performed on the operands.

Although embodiments of the invention are not limited in this respect, instruction decoder 20 may have two modes of operation (-204-), selected, for example, by setting the contents of decoding mode register 38 to one of two predetermined values.

In the first mode, “unfused” mode, instruction decoder 20 may decode macroinstructions received from instruction cache memory 12 into one or more simple u-ops (-208-), where a “simple u-op” is a u-op that may be executed by one of the execution units of execution cluster 22.

In the second mode, “fused” mode, instruction decoder 20 may decode macroinstructions receive from instruction cache memory 12 into one or more simple u-ops and/or fused u-ops (-212-), as appropriate, depending upon the type of the macroinstruction. A “fused u-op” is a u-op that combines two or more simple u-ops for the purpose of reducing overhead. Although embodiments of the invention are not limited in this respect, fused u-ops may combine simple u-ops that ought not to be executed out-of-order. For example, when the result of a simple u-op is the operand of another simple u-op, it may be appropriate to combine the simple u-ops into a fused u-op.

A fused u-op may have two or more dependent or independent execution steps, where at each dependent or independent step, one simple u-op is executed. For example, a store macroinstruction may be decoded into a fused u-op combining the simple u-op “store address” and the simple u-op “store data”.

Although embodiments of the invention are not limited in this respect, the mode of operation of instruction decoder 20 may be selectively set for each macroinstruction received from instruction cache memory 12. As a default, instruction decoder 20 may be set to decode macroinstructions using fused mode. Unfused decoding mode may be dynamically used in some cases of exception resolving, as will be described hereinbelow.

Register alias table 24 may be coupled to instruction decoder 20 through MUX 36, and may receive from instruction decoder 20 op-codes in the same order that they were generated from the macroinstructions (-216-).

Although embodiments of the invention are not limited in this respect, in some situations, such as, for example, during handling of exceptions, MUX 36 may decouple instruction decoder 20 from register alias table 24, and may couple instead uROM 34 to register alias table 24. uROM 34 may store sequences of u-ops, such as, for example, exception handlers, and may send these u-ops to register alias table 24 through MUX 36 (-216-), as will be described hereinbelow.

Register alias table 24 may allocate and rename the u-op and assign EUs of execution cluster 22 to execute each u-op (-224-). For a simple u-op, register alias table 24 may assign one EU to execute it, and for a fused u-op, register alias table 24 may assign the same or different execution units to execute the steps of the fused u-op. After assigning EUs of execution cluster 22 to execute each u-op, register alias table 24 may forward the op-codes and the EU assignment(s) to reservation station 26 and reorder buffer 28 (-228-).

Reservation station 26 may store internally the op-codes and the EU assignment(s) for each op-code, and may then wait until the operands for each u-op are available. Operands may be received by reservation station 26 from instruction decoder 20 via signals 40, from reorder buffer 28 at allocation, and from execution cluster 22 via signals 44 (writeback) as execution results of other u-ops. For loads, data may be received from data cache memory 10, which is similar to a writeback.

Each operand received is stored together with the corresponding op-code. When all operands are available, reservation station 26 may check for the availability of some resources of processor core 14, and when available, reservation station 26 may dispatch the u-op to the assigned EUs via signals 46 (-232-).

Reservation station 26 may store and handle more than one u-op at a time. The conditions for execution of one u-op may be fulfilled before the conditions for execution of a u-op that was received earlier. Consequently, u-ops may be dispatched and executed in an order that may be different from the order in which instruction decoder 20 or uROM 34 generated them.

Reservation station 26 may store op-codes and operands of several u-ops. At any given time, depending on the rate at which reservation station 26 receives op-codes from register alias table 24, and on the rate at which reservation station 26 dispatches u-ops to execution cluster 22, reservation station 26 may store no u-ops or one or more u-ops. Reservation station 26 may continue dispatching u-ops to execution cluster 22 as long as there is at least one u-op stored inside it (-236-).

When reservation station 26 receives a fused u-op from register alias table 24, reservation station 26 may produce logically consecutive simple u-ops equivalent to the steps of the fused u-op. For example, the first step of the fused u-op may be a fetch (load) of a floating point operand from data cache memory 10, and the execution of this step may be assigned to load EU 32. The second step of the fused u-op may be a multiplication of the floating point operand fetched by load EU 32 from data cache memory 10 in the first step, with a second floating point operand, and the execution of this step may be assigned to floating point EU 30.

Reservation station 26 may produce a simple u-op that is equivalent to the first step of the fused u-op and may dispatch this simple u-op to load EU 32 via signals 46. Reservation station 26 may receive the fetched floating point operand from load EU 32 via signals 44, and may store the fetched floating point operand together with the op-code of the fused u-op. Reservation station 26 may then produce a second simple u-op, which is equivalent to the second step of the fused u-op, and may dispatch this second simple u-op to floating point EU 30 via signals 46.

After reservation station 26 dispatches a u-op to an EU, the u-op is executed by the EU. If no exception occurs during execution of the u-op, then the execution results will be sent to reorder buffer 28 and/or reservation station 26 via signals 44. If an exception occurs (-234-), then a microcode exception handler will be activated (-240-), as will be described hereinbelow.

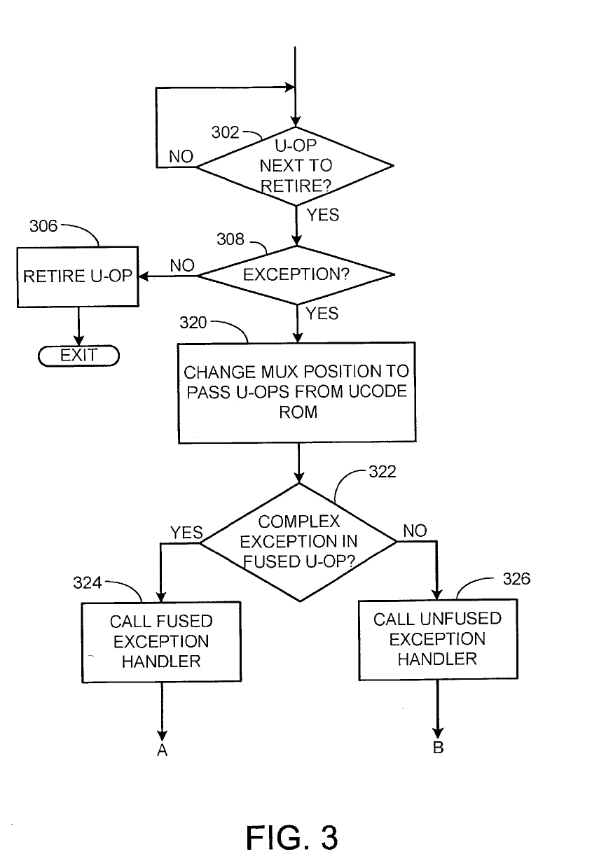

Reference is now made additionally to FIG. 3, which is a flowchart illustration of a method implemented by the reorder buffer, according to at least one embodiment of the invention.

Reorder buffer 28 may receive execution results from execution cluster 22 via signals 44 and may retire them according to the original order of u-ops, as received from instruction decoder 20 or uROM 34. Reorder buffer 28 may retire a u-op if the u-op is ready to be retired and if the u-op is next to be retired, according to the original order of u-ops (-302-).

When execution results become available for the u-ops that are next to be retired, reorder buffer 28 may retire these execution results to retired register file 16 via signals 48 (-306-). Reorder buffer 28 may retire simple u-ops after receiving the execution results from execution cluster 22, and may retire fused u-ops after receiving the execution results of the last execution step from execution cluster 22.

During the execution of a u-op in execution cluster 22, an exception may occur. An exception is a situation that execution cluster 22 cannot handle by itself. Therefore, execution cluster 22 may report the existence of the exception, and the exception may be handled by an exception handler stored in uROM 34.

An exception handler may include microcode, which is a sequence of u-ops. Although embodiments of the invention are not limited in this respect, the microcode of an exception handler may be designed to resolve a specific exception.

For example, although embodiments of the invention are not limited in this respect, floating point exceptions may occur as a result of floating point standards such as overflow or underflow, as a result of internal implementations such as denormal and microcode pre-assists, and as a result of peculiarities of a particular instruction set architecture such as stack overflow and underflow for a stack machine.

Although embodiments of the invention are not limited in this respect, uROM 34 may include different exception handlers for each of those exemplary exceptions.

As previously described, when reservation station 26 receives a fused u-op from register alias table 24, reservation station 26 may produce consecutive simple u-ops equivalent to the steps of the fused u-op, and may dispatch these simple u-ops to execution cluster 22. However, when an exception occurs during the execution of a simple u-op that is a step of a fused u-op, the exception may be handled differently than when the same exception occurs during the execution of a simple u-op that is not a step of a fused u-op, as will be described hereinbelow.

For that purpose, uROM 34 may include exception handlers 50 to resolve exceptions of simple u-ops that are not steps of fused u-ops, and in addition, exception handlers 52 to resolve exceptions of simple u-ops that are steps of fused u-ops.

Once an exception occurs during the execution of a u-op in execution cluster 22 (-308-), execution cluster 22 may send information about the exception to reorder buffer 28, which may store the exception information internally. Although embodiments of the invention are not limited in this respect, after storing the exception information internally, reorder buffer 28 does not further handle the exception until the corresponding u-op becomes next to be retired.

When the corresponding u-op becomes next to be retired, reorder buffer 28 does not retire it to retired register file 16, since the u-op does not have a valid result. Instead, via signals 54, reorder buffer may set MUX 36 to decouple instruction decoder 20 from register alias table 24, and to couple uROM 34 to register alias table 24 (-320-).

If the exception is a complex exception occurring during execution of a fused u-op (-322-), for example, a floating point exception, then reorder buffer 28 will call upon fused exception handler 52 (-324-), whose flow is marked by point A.

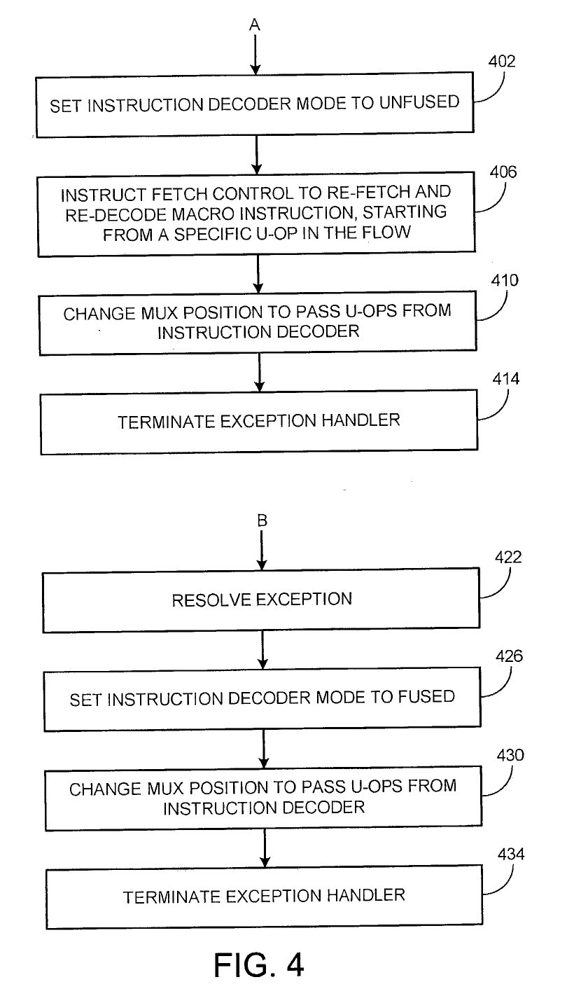

Reference is now made additionally to FIG. 4, which is a flowchart illustration of a method implemented by the uROM, according to at least one embodiment of the invention.

Receiving the exception information from reorder buffer 28 via signals 54, the flow of uROM 34 may continue from point A in FIG. 4. Fused exception handler 52 may set decoding mode register 38 to a predetermined value to select the unfused mode for instruction decoder 20 (-402-). This may be achieved by sending a ucode u-op that is executed by control register EU 31. Fused exception handler 52 may then instruct fetch control 18 to re-fetch and re-decoder the macroinstruction, starting from a specific u-op in the flow (-406-). The last u-op of fused exception handler 52 may set MUX 36 to decouple uROM 34 from register alias table 24 and to couple instruction decoder 20 to register alias table 24 (-410-) and fused exception handler 52 may terminate itself (-414-).

As explained hereinabove with respect to FIG. 2, when instruction decoder 20 is in unfused mode, instruction decoder will decode the macroinstruction fetched by fetch control 18 into instruction cache memory 12 into one or more simple u-ops (-208-). When the simple u-ops are dispatched (-228-), the same exception that arose during execution of the fused u-op will arise in the execution of one or more of these simple u-ops, and in the flow of FIG. 3, reorder buffer 28 may call unfused exception handler 50 to resolve this exception (-326-). The flow of unfused exception handler 50 is shown in FIG. 4.

Returning to FIG. 4, unfused exception handler 50 may resolve the exception (-422-). Unfused exception handler 50 may then set decoding mode register 38 to a predetermined value to select the fused mode for instruction decoder 20 (-426-). This may be achieved by sending a ucode u-op that is executed by control register EU 31. The last u-op of unfused exception handler 50 may set MUX 36 to decouple uROM 34 from register alias table 24 and to couple instruction decoder 20 to register alias table 24 (-430-) and unfused exception handler 50 may terminate itself (-434-).

While certain features of the invention have been illustrated and described herein, many modifications, substitutions, changes, and equivalents will now occur to those of ordinary skill in the art. In a non-limiting example, instead of storing the mode of the instruction decoder in a register, a bit indicating the mode of the instruction decoder may be added to the macroinstruction before it is decoded. It is, therefore, to be understood that the appended claims are intended to cover all such modifications and changes as fall within the true spirit of the invention.

What is claimed is:

1. A method comprising:
if an exception occurs during execution of a fused micro-operation in a processor, the fused micro-operation being one of an original set of one or more micro-operations decoded from a macroinstruction by an instruction decoder of the processor, having the instruction decoder decode the macroinstruction solely into simple micro-operations, so that the fused micro-operation is issued by the instruction decoder as two or more simple micro-operations.

2. The method of claim 1, further comprising:
enabling the instruction decoder to decode subsequent macroinstructions into one or more fused micro-operations.

3. The method of claim 1, further comprising:
resolving the exception when it occurs during execution of the two or more simple micro-operations.

4. A method comprising:
setting a mode of an instruction decoder of a processor to unfused decoding mode or to fused decoding mode for a macroinstruction independently of the mode of the instruction decoder for other macroinstructions, wherein in the unfused decoding mode, the instruction decoder is to decode the macroinstruction solely using one or more simple micro-operations, and in the fused decoding mode, the instruction decoder is to use one or more fused micro-operations if appropriate when decoding the macroinstruction.

5. The method of claim 4, further comprising:
setting the instruction decoder to fused decoding mode by default.

6. The method of claim 5, further comprising:
setting the instruction decoder to infused decoding mode dynamically by microcode for a particular macroinstruction if an exception has occurred during execution of a fused micro-operation previously decoded from the particular macroinstruction.

7. The method of claim 6, further comprising:
setting the instruction decoder to fused decoding mode dynamically by said microcode once said exception has been resolved during execution of a simple micro-operation decoding from the particular macroinstruction.

8. A processor comprising:
an instruction decoder having an unfused decoding mode and a fused decoding mode, wherein a macroinstruction that would be decoded in fused decoding mode into one or more micro-operations at least one of which is a fused micro-operation is to be decoded in unfused decoding mode solely into two or more simple micro-operations, and wherein microcode is to dynamically set the mode of said instruction decoder.

9. The processor of claim 8, further comprising:
a fetch control to fetch a previously fetched macroinstruction from a system memory to one or more cache memories for use by the processor.

10. The processor of claim 9, further comprising:
a memory to store said microcode, wherein if an exception occurs during execution of a fused micro-operation, said microcode is to set the instruction decoder to unfused decoding mode and to cause the fetch control to fetch the previously fetched macroinstruction for the previously fetched macroinstruction.

11. A processor comprising:
an instruction decoder having an unfused decoding mode and a fused decoding mode, wherein a macroinstruction that would be decoded in fused decoding mode into one or more micro-operations at least one of which is a fused micro-operation is to be decoded in unfused decoding mode solely into two or more simple micro-operations; and
means for dynamically setting the mode of said instruction decoder.

13. The processor of claim 12, further comprising:
a memory to store said microcode, wherein if an exception occurs during execution of the fused micro-operation, said microcode is to cause the instruction decoder to decode the at least one macroinstruction in unfused decoding mode.

14. The processor of claim 13, further comprising:
a register coupled to the instruction decoder to store an indication of the mode of the instruction decoder.

15. A processor comprising:
means for decoding a macroinstruction into one or more micro-operations at least one of which is a fused micro-operation; and
means for decoding said macroinstruction solely into two or more simple micro-operations when an exception occurs during execution of said fused micro-operation.

16. The processor of claim 15, further comprising:
a fetch control to fetch said macroinstruction from a system memory to one or more cache memories for use by said means for decoding said macroinstruction solely into two or more simple micro-operations.

17. The processor of claim 15, further comprising:
means for determining that said exception is to be resolved by decoding said macroinstruction.

18. An apparatus comprising:
a voltage monitor;
a system memory to store macroinstructions and data for the macroinstructions; and
a processor including at least an instruction decoder having an unfused decoding mode and a fused decoding mode, wherein a macroinstruction that would be decoded in fused decoding mode into one or more micro-operations at least one of which is a fused micro-operation is to be decoded in unfused decoding mode solely into two or more simple micro-operations, the processor also including a register coupled to the instruction decoder to store an indication of the mode of the instruction decoder.

19. The apparatus of claim 18, wherein the processor further comprises:
a memory to store microcode for exception handlers, wherein if an exception occurs during execution of the fused micro-operation, one of the exception handlers is to cause the instruction decoder to decode the at least one macroinstruction in unfused decoding mode.

20. The apparatus of claim 18, wherein the instruction decoder is set to fused decoding mode by default.

21. An article having stored thereon microcode, which when executed by a processor, results in resolving an exception occurring during execution of a fused micro-operation by the processor, wherein resolving the exception comprises:
fetching the macroinstruction from which the fused micro-operation was decoded; and
decoding the macroinstruction using simple micro-operations.

22. The article of claim 21, wherein resolving the exception further comprises terminating execution of the fused micro-operation.

23. The article of claim 22, wherein resolving the exception further comprises resolving the exception when the exception occurs during execution of one of the simple micro-operations.

24. An article having stored thereon microcode, which when executed by a processor, results in:
setting dynamically a mode of an instruction decoder of said processor to unfused decoding mode or fused decoding mode.

25. The article of claim 24, wherein said microcode includes a fused exception handler, which when executed by said processor, results in:
setting said mode to unfused decoding mode when an exception occurs during execution of a fused micro-operation by said processor, said fused micro-operation having been decoded from a macroinstruction.

26. The article of claim 25, wherein said fused exception handler further results in:
causing said instruction decoder to decode said macroinstruction in unfused decoding mode into two or more simple micro-operations.

27. The article of claim 26, wherein said microcode includes an unfused exception handler, which when executed by said processor, results in:
when said exception reoccurs during execution of a simple micro-operation decoded from said macroinstruction, setting said mode to fused decoding mode once said exception has been resolved by said unfused exception handler.
